(19) United States
(12) Patent Application Publication
(10) Pub. No.: US 2020/0361307 A1
(43) Pub. Date: Nov. 19, 2020

(54) Magnetic Tip Valve

(71) Applicants: Sean Joseph Ciccone, POTTSTOWN, PA (US); Michael Anthony Ciccone, Boyertown, PA (US)

(72) Inventors: Sean Joseph Ciccone, POTTSTOWN, PA (US); Michael Anthony Ciccone, Boyertown, PA (US)

(21) Appl. No.: 16/849,837

(22) Filed: Apr. 15, 2020

Related U.S. Application Data
(60) Provisional application No. 62/920,479, filed on May 1, 2019.

(51) Int. Cl. B60K 15/035; F16K 24/04; F16K 31/08

(52) U.S. Cl. CPC B60K 15/03519; B60K 2015/03263; F16K 31/08; F16K 24/04

(57) ABSTRACT

A Magnetic Tip Valve mounted in the top of a fluid container described as open, allowing air to flow through it while upright and closed when rotated preventing fluid from escaping the container. A ball within a tube attracted by a magnet moves toward a seat which is located between the ball and magnet enhancing the function of the tip valve. The attraction between the ball and magnet being of sufficient strength to enhance the valve closure characteristics while not being strong enough to hold the valve closed while upright.

### CROSS REFERENCE TO RELATED APPLICATIONS

Inventor Sean Ciccone filed provisional patent application No. 62/920,479 with filing date May 1, 2019.

### STATEMENT REGARDING FEDERALLY SPONSORED RESEARCH AND DEVELOPMENT

This invention was not made with government support.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

There are no prior disclosures of this invention.

### BACKGROUND OF THE INVENTION

### (1) Field of the Invention

This invention relates to containers of fluid like fuel tanks. More specifically, this invention has to do with venting fuel tanks but then closing the vent if the fuel tank is tipped over.

### (2) Description of Related Art Including Information Disclosed Under 37 CFR 1.97 and 1.98

Tip valves or rollover valves mounted in fuel tank caps or directly into fuel tanks composed of a ball or balls and a seat which is open or vented while upright but then closes when the tank is tipped or rolled over.

### BRIEF SUMMARY OF THE INVENTION

The Magnetic Tip Valve has a ball within a tube moved onto a seat and seals upon rotation from upright. The magnet is positioned to enhance the valve closing characteristics allowing the valve to close at lower tip angles. The Magnetic Tip Valve may be used in the top of a fuel tank or any other tank containing fluid. It can be built into the tank itself or into a cap to vent the tank but also close if the tank is tipped over.

### BRIEF DESCRIPTION OF THE SEVERAL VIEWS OF THE DRAWINGS

FIG. 1 is a 3D downward front view of body (4) which serves as the housing for the rest of the parts.

FIG. 2 is a front view of body (4).

FIG. 3 is a 3D upward front view of body (4). Body (4) in this example having 1⅜″-12 threads to screw into a gas tank. Body (4) has holes through it to allow venting of the tank, Body (4) also has a top designed to accept a filter to prevent debris from entering the fuel tank.

FIG. 4 is a front view showing section line of body (4).

FIG. 5 is a halved section view of the assembly. In FIG. 5, the ball (3) is in the closed position against seat (2) attracted by the magnet (1) being retained within the body (4) by the baffle foam (5).

FIG. 6 is an exploded view of the assembly showing how the magnet (1) goes into the top of body (4) while the ball (3) and baffle (5) go into the bottom.

FIG. 7 is a 3D downward front view of body (7) which serves as the housing for the rest of the parts.

FIG. 8 is a front view of body (7).

FIG. 9 is an upward front view of body (7) and retaining pin (8).

FIG. 10 is a front view showing section line of body (7).

FIG. 11 is a halved section view of the assembly. In FIG. 11, the ball (3) is against the seat (2) attracted by magnet (6) being retained within body (7) by retaining pin (8).

FIG. 12 is an exploded view of the assembly showing how the magnet (6), ball (3), and retaining pin (8) go into the bottom of the body (7).

FIG. 13 is a labeled representation of the ball in the lower position in the tube allowing tank venting while upright versus the ball moving against the seat/ramp being attracted by the magnet while rotated 90 degrees which prevents fluid from escaping.

FIG. 14 is a labeled representation of the ball in the tube against the seat attracted by the magnet showing how fluid trying to escape the tank pushes it toward the seat while air trying to enter the tank pushes it away from the seat.

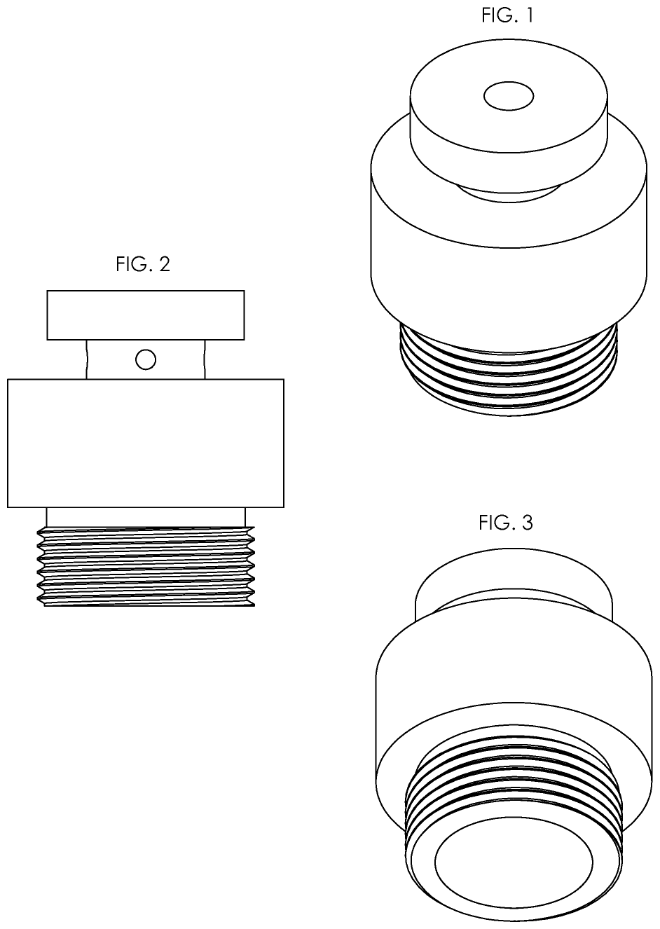

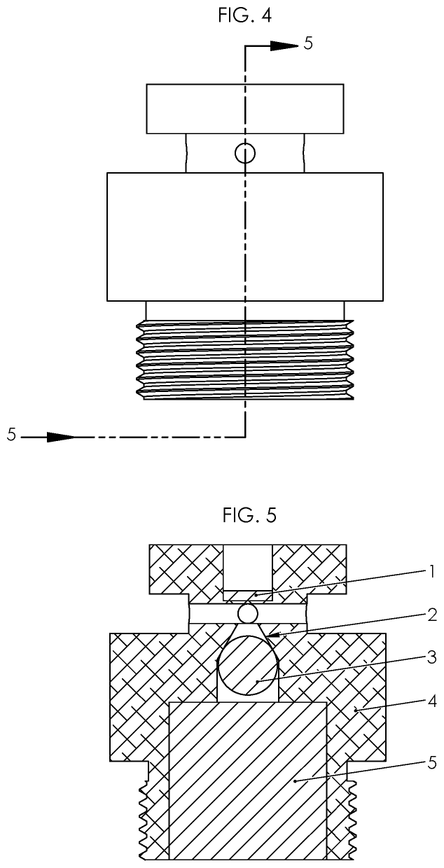

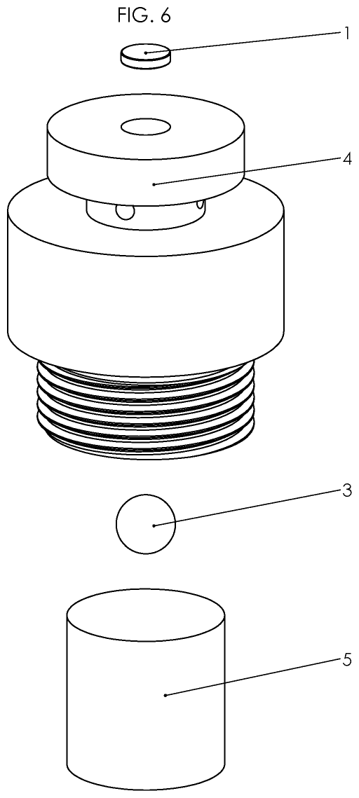

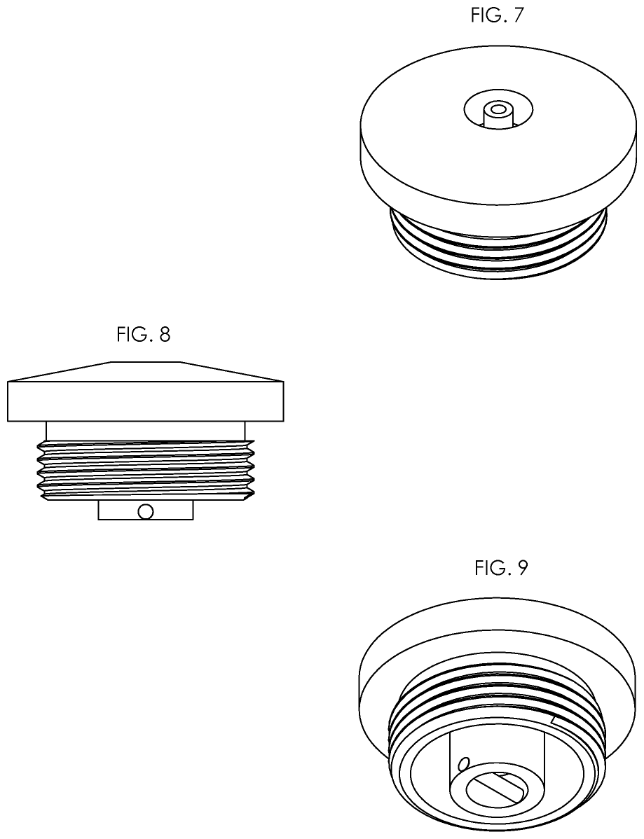

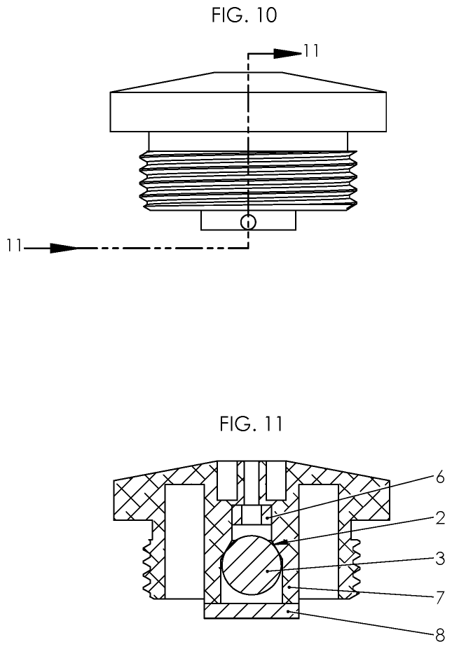

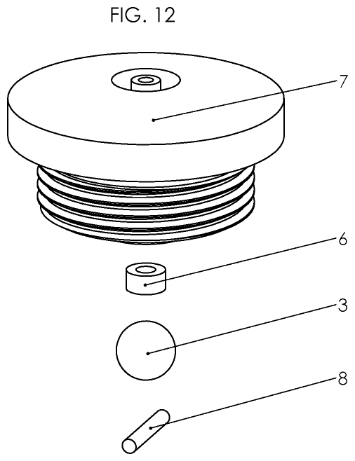

### DETAILED DESCRIPTION OF THE INVENTION

(1) is a 0.0625″ thick 0.3125″ OD plated neodymium magnet. (6) is a 0.25″ OD 0.125″ tall neodymium donut magnet. The neodymium magnets were chosen for tight tolerances, consistency, and magnetic strength, and are meant to be encapsulated in gasoline and ethanol resistant epoxy to avoid corrosion of the magnet. (2) represents the conical surface or seat which the ball seals against. The ball (3) is 0.375″ OD 304 stainless steel, chosen for its chemical resistance as well as being paramagnetic. Body (4) and body (7) can be machined from 1.75″ OD aluminum alloy rod such as 6061 or HDPE plastic. The 6061 and HDPE were chosen for their resistance to gasoline and ethanol as well as other physical properties. It could also be injection molded and possibly machine finished. Ideally, the bodies would be made on a cnc lathe. I used an old manual lathe and a benchtop mill to make functional prototypes. The baffle (5) is 1″ OD 1″ tall polyurethane gas tank baffle foam chosen to allow the tank to vent through it, to hold the ball up in position, and to be gasoline and ethanol resistant. It was made with a tufting drill bit otherwise used for upholstery. (8) is a 0.09375″ OD 0.6″ long 7075 pin to retain the ball within the body.

The primary application and use for this Magnetic Tip Valve is in motorsports. Using quarter midget racing as an example; the Magnetic Tip Valve could be directly and permanently installed into the top of the fuel tank by machining the part then welding into the tank. The tank being 4″ OD and 8″ long aluminum. The Magnetic Tip Valve could also be within the fuel tank cap and screwed into the top of the fuel tank achieving virtually the same thing.

The Magnetic tip valve while upright during normal operation, allows the fuel tank to vent preventing vapor lock and pressure build up from thermal expansion. If the tank and valve are rotated, the ball moves from its resting position onto the seat where it is enhanced by the pull of the magnet. Practically any tip valve closure angle is achievable by changing the size of the magnet, the strength of the magnet, or the distance between the ball and magnet. Material variations will also affect the function.

The Magnetic Tip Valve has the potential to greatly enhance racing safety and could easily have a broad range of applications on any container of fluid.

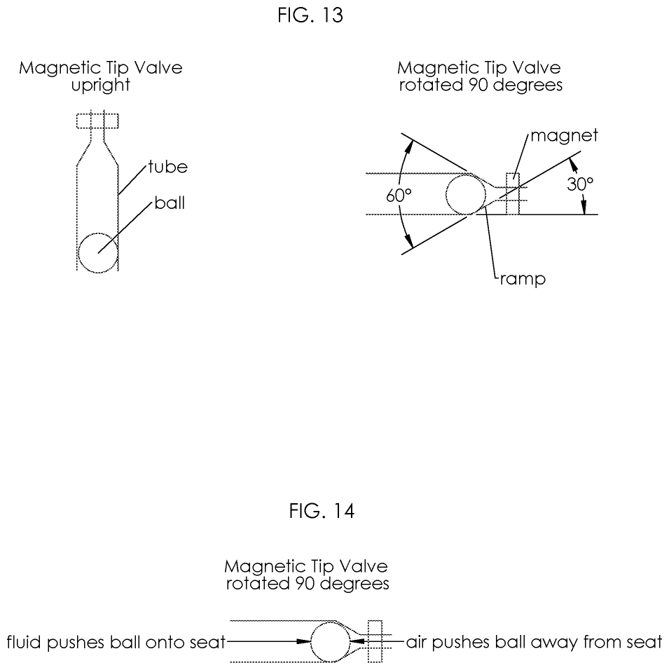

1. A tip valve being a ball in a tube. The ball being at a lower position while upright and allowing tank venting. When rotated, the ball moves toward a seat and seals the tank. The seat being machined at 60 degrees, when tip valve is rotated 90 degrees from upright, the ball has a 30 degree ramp to go up before its able to seal. I claim that the Magnetic Tip Valve allows the valve to close at lower tip angles because the attractive force between the ball and magnet pulling the ball up the ramp resulting in enhanced valve closure characteristics. See FIG. 13.

2. Within a tank of fluid, like a fuel tank, as fuel leaves the tank, an equal volume of air replaces the fluid. In a tip valve, there are several forces at work to move the ball onto the seat or move it away from the seat. The fluid trying to flow out moves the ball onto the seat. Air trying to get into the tank moves the ball away from the seat. I claim that the attraction between the ball and magnet of the Magnetic Tip Valve overcomes the force of air going into the tank resulting in enhanced valve closure characteristics. See FIG. 14.

3. When race cars are involved in crashes, the race car can be off the ground, moving as a projectile. In this scenario, gravity is affecting all things the same, and the only force present within the Magnetic Tip Valve is the attraction between the ball and magnet. I claim that the Magnetic Tip Valve will pull the ball toward the seat when the race car it is mounted in has become a projectile resulting in enhanced valve closure characteristics.
